(19) United States
(12) Patent Application Publication
(10) Pub. No.: US 2026/0340264 A1
(43) Pub. Date: Oct. 29, 2026

(54) SYSTEMS AND METHODS FOR INTELLIGENT DOCUMENT GENERATION

(71) Applicant: WELLS FARGO BANK, N.A., San Francisco, CA (US)

(72) Inventors: Booma KANNAN, Columbus, OH (US); Josh PLAHN, Portland, OR (US)

(73) Assignee: WELLS FARGO BANK, N.A., San Francisco, CA (US)

(21) Appl. No.: 19/400,711

(22) Filed: Nov. 25, 2025

Related U.S. Application Data
(60) Provisional application No. 63/793,871, filed on Apr. 24, 2025.

(51) Int. Cl. G06F 40/166; G06F 40/106; G06F 40/117; G06F 40/40

(52) U.S. Cl. CPC G06F 40/166; G06F 40/106; G06F 40/117; G06F 40/40

(57) ABSTRACT

In certain embodiments, a method is provided that involves multiple stages of document processing and generation. The method performs a first phase in which a collection of documents is obtained from various repositories. For each document, an extraction model identifies both content-related and structural features. These features are then broken down into document block vectors, which are subsequently stored within a vector database. In the next phase, the method focuses on creating a target document. This involves accepting user input that specifies the desired configuration for the target document. Based on this configuration, relevant document block vectors are retrieved from the vector database. A generation model then uses these vectors, along with the user-defined configuration, to produce targeted text output. The targeted text output is transformed into the completed target document, tailored to the user's requirements.

### CROSS-REFERENCE TO RELATED APPLICATIONS

This application claims priority to U.S. Provisional Patent Application No. 63/793,871, filed on Apr. 24, 2025, and entitled “SYSTEMS AND METHODS FOR INTELLIGENT DOCUMENT GENERATION,” the entirety of which is hereby incorporated by reference herein.

### FIELD OF INVENTION

The present disclosure generally relates to generative artificial intelligence (“GenAI”), and more specifically to systems and methods for intelligent document generation within content management systems.

### BACKGROUND

Content management systems (“CMS”), widely available across a variety of sectors, generally rely on released software that manages content rules and associated data for generating documents. CMS software generally consists of a user interface for users and content writers to log in and manually set up, create content templates and product documents for application outside the content management system. Depending on the context, manually generating documents via CMS software can be a lengthy process.

### SUMMARY

According to certain examples, a method is described. The method can include performing a set of operations. The operations can include, in a first stage, generating a set of document block vectors via first stage operations. The first stage operations can include retrieving a set of documents from one or more document repositories and extraction, for each document of the set of documents, and via an extraction model, content features and structural features. The first stage operations can include decomposing the content features and structural features into the set of document block vectors and storing the set of document block vectors in a vector database. The operations, in a second stage, can include generating a target document. The second stage operations can include receiving user input, including a configuration of the target document, and retrieving, based on the configuration, one or more document block vectors from the vector database. The second stage operations can further include, generating, via a generation model, target text output based on the one or more document block vectors and the configuration, and converting the target text output into the target document.

Another example relates to a system including one or more processors configured to perform operations. The operations can include, in a first stage, generating a set of document block vectors via first stage operations. The first stage operations can include retrieving a set of documents from one or more document repositories and extraction, for each document of the set of documents, and via an extraction model, content features and structural features. The first stage operations can include decomposing the content features and structural features into the set of document block vectors and storing the set of document block vectors in a vector database. The operations, in a second stage, can include generating a target document. The second stage operations can include receiving user input, including a configuration of the target document, and retrieving, based on the configuration, one or more document block vectors from the vector database. The second stage operations can further include, generating, via a generation model, target text output based on the one or more document block vectors and the configuration, and converting the target text output into the target document.

A further example relates to a non-transitory computer readable medium comprising instructions that, when executed by one or more processors, cause the one or more processors to perform operations. The operations can include, in a first stage, generating a set of document block vectors via first stage operations. The first stage operations can include retrieving a set of documents from one or more document repositories and extraction, for each document of the set of documents, and via an extraction model, content features and structural features. The first stage operations can include decomposing the content features and structural features into the set of document block vectors and storing the set of document block vectors in a vector database. The operations, in a second stage, can include generating a target document. The second stage operations can include receiving user input, including a configuration of the target document, and retrieving, based on the configuration, one or more document block vectors from the vector database. The second stage operations can further include, generating, via a generation model, target text output based on the one or more document block vectors and the configuration, and converting the target text output into the target document.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

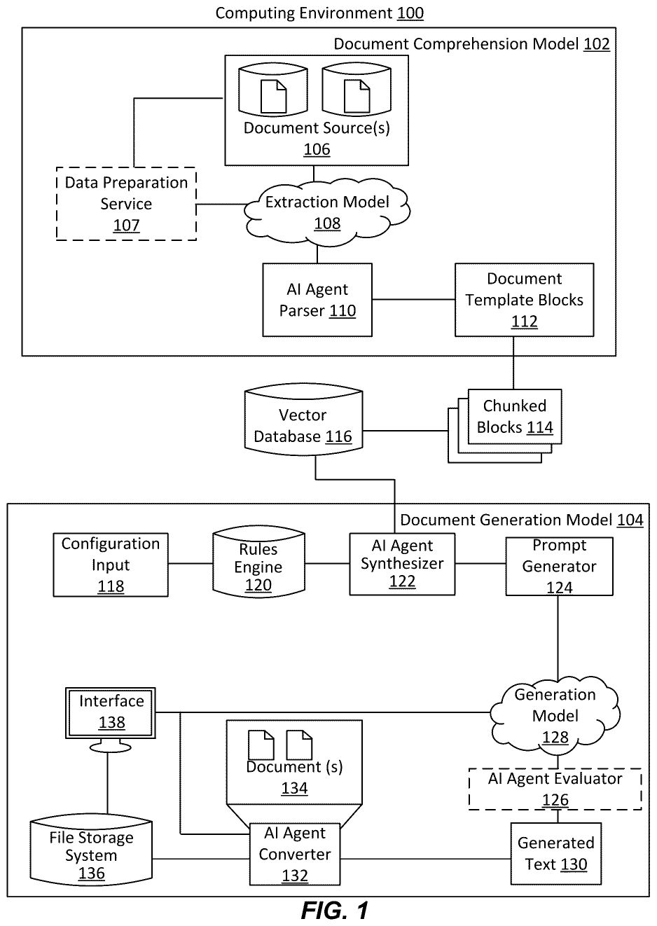

FIG. 1 shows a computer environment for implementing an intelligent document generation service, according to certain examples.

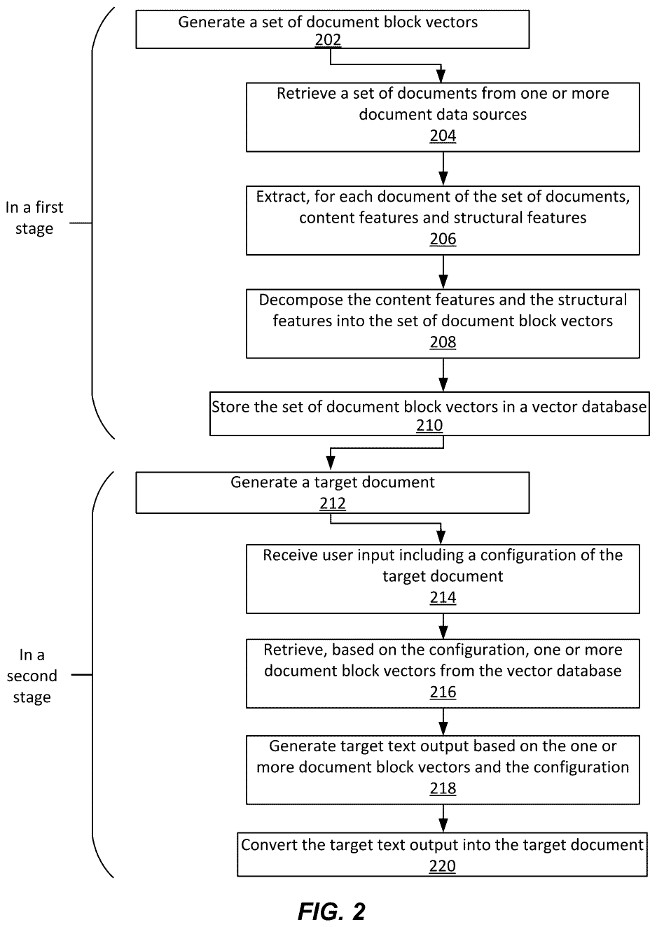

FIG. 2 shows an example process for generating documents via an AI-augmented content management system, according to certain examples.

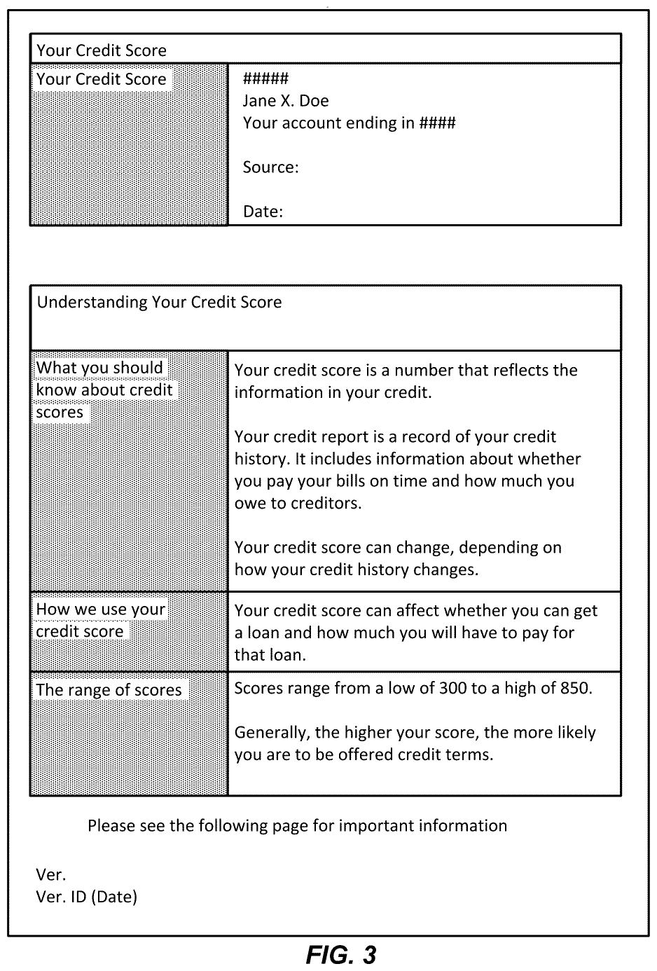

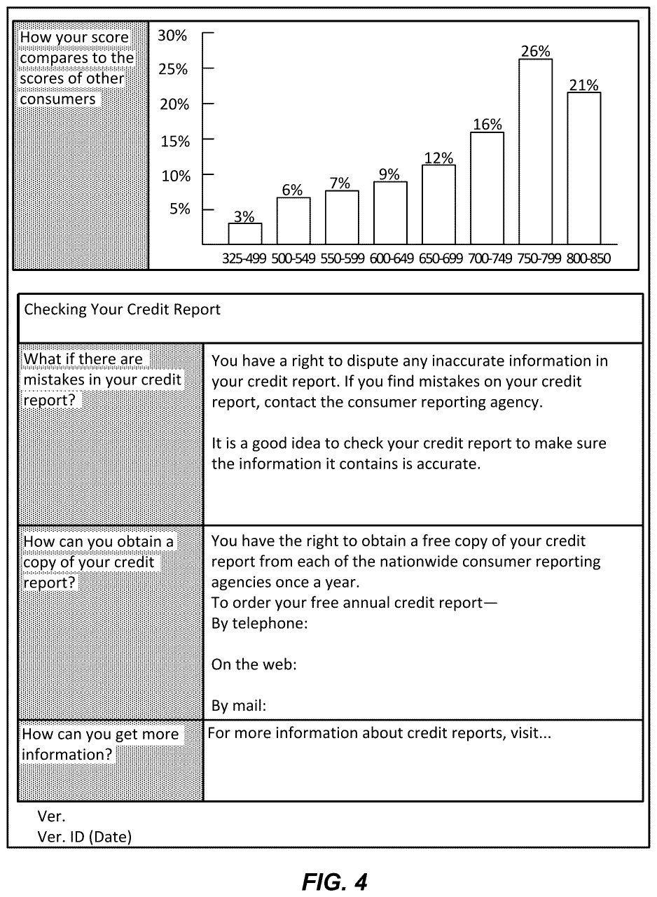

FIGS. 3-4 show a formatted document generated via an AI-augmented content management system, according to certain examples.

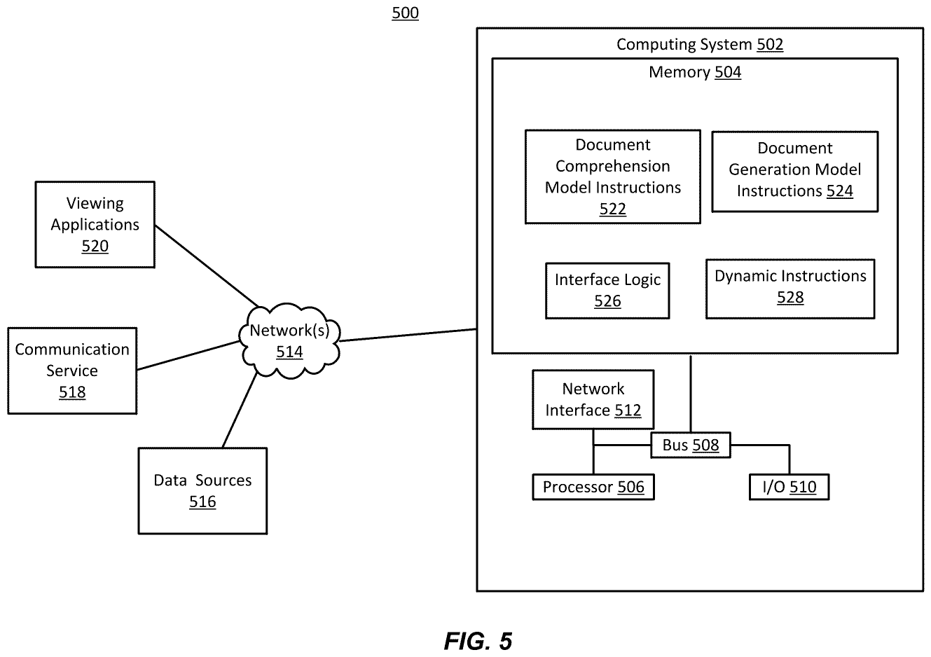

FIG. 5 shows a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used in another example to yield a still further example. Thus, it is intended that this disclosure include modifications and variations as come within the scope of the appended claims and their equivalents.

Typical content management systems (“CMS”) are rule-based software systems. While some CMS may include machine-learning techniques to automate some tasks, CMS remain heavily rule-based and require manual input through each step of the content generation process. Thus, developers, in looking to deploy various content, must typically create such content via manual manipulation of documents in the CMS. As an example, a disclosure document containing various terms and conditions must be manually generated. Each of various products may require its own template. For instance, a credit card disclosure document will require terms and conditions, APR information, and the like unique to that card, and unique to the recipient.

Current interfaces within CMS allow for manual creation of such templates. The process typically begins with a user, such as a content writer logging into a CMS portal. The content writer, in generating a given document, will then manually enter the content into the template, where the content writer must consult various documents and references in forming the disclosure document. The disclosure document may thus include a series of content templates, each manually created, and each manually pieced together to form the disclosure document. Each template can contain content, including static content (meaning the user manually inserted the language) and dynamic content which may be linked to various databases. An example of dynamic content can include an APR or other frequently changing term which may be consistently updated within a database or platform.

Certain aspects described herein provide improvements over prior techniques for generation, management, and evaluation of templates and documents within content management systems. Rather than relying on the manual generation of templates and documents via CMS, the described techniques provide an improved approach leveraging various machine-learning models, including large language models (“LLMs”) to efficiently generate templates, and output documents which may be applied in a variety of contexts including within healthcare, financial, and technology based industries.

A multi-stage, multi-modal, agentic AI approach for generation of templates and documents is described. In a first stage, a document comprehension model can receive and retrieve documents from a variety of data sources, in a variety of contexts, such as PDF- and HTML-formatted documents related to financial terms and policies. The document comprehension model can extract information from each received document, including extracted content features and extracted structural features. Once relevant features are extracted, the extracted features including the extracted content and extracted structure can be chunked into discrete blocks, where the discrete blocks, containing the extracted features, are then stored in a vector database or stored for retrieval according to a document generation model in a second stage of operations.

In the second stage, a document generation model can generate documents in response to requests received via a variety of user interfaces. The requests can include configurations and rules indicating desired features of the generated document, such configurations including rules related to terms, recipients, products, code, and the like. In response to receiving the user input configuration, the document generation model can ingest source data (i.e., the discrete blocks of extracted features), and synthesize the source data with the received configuration to generate query prompts. The query prompts may be fed into a generation model which may include a new instance of the same LLM or a different LLM than the extraction model. The generation model may then produce output text, which, upon review, can then be converted into final documents for storage within the improved CMS, for subsequent retrieval and use in a variety of applications.

Certain aspects described herein overcome the above identified inefficiencies in electronic user interfaces and event-responsive user applications. As described, a specific set of rules for generating target documents within an augmented content management system provide improvements over previous content management systems. For example, extraction of specific content features and structural features, segmented into reduced blocks and transformed into vectors for storage in a vector database and subsequent retrieval in a second stage of operations describe meaningful requirements for improving the functionality of content management systems. Such techniques provide a particularized benefit to augmented content generation, by providing an efficient means for a document generation model to query a vector database in generating prompts which are then used to generate documents. Compared to previous content management systems, which would rely on subjective determinations by content developers, the described automatic operations apply specific rules to generate content more useful than that previously manually created by content developers.

In an example use case, the document generation model can generate disclosure letters for a variety of products, such as financial service products (e.g., home lending products, credit products, deposit products, and etc.). In other examples, the document generation model can generate disclosure letters for consumer goods products, such as household goods, children's products, food, cosmetics, medical devices, and or other types of products where a disclosure letter may be needed or appropriate. The document generation model can be trained using sample letters, either in PDF or other formats. Multiple agents can orchestrate the execution of the document generation model, including via a content parser sub-agent, a content retrieval augmented generation (“RAG”) sub-agent, and a content generator sub-agent. The content parser sub-agent (referred to as an extraction model below) can execute instructions for parsing the document, understanding the context, and extracting the content into meaningful outputs (e.g., Markdown or JSON), before passing the output to the content RAG builder sub-agent. The content parser sub-agent (referred to as an AI agent parser below) can be trained on letter training data in order to generate the output, JSON or otherwise. The Content RAG builder sub-agent (referred to as an AI agent synthesizer) provides a custom retrieval tool that can process the output Markdown or JSON data from the parser, chunk and store the data as vector embeddings in a RAG storage system (e.g., Chroma DB). The content generator sub-agent (also referred to as the document generation model below) can then process user requests, retrieve the vector embeddings, and generate new content.

### Example Computing Environment for Implementing an AI-Augmented Content Management System

FIG. 1 shows an implementation of an AI-augmented content management system, according to certain examples. The embodiments according to FIG. 1 are shown to illustrate the logical and physical implementation of the AI-augmented content management system according to certain embodiments. Other embodiments, however, are possible. For instance, certain components may be shown as distinct components to illustrate the progression of the data flow, while according to some embodiments, the physical implementation of such components may be implemented across the same device. It is to be appreciated that the example embodiments according to FIG. 1 are provided for illustrative purposes. Examples of implementations of the computing environment 100 capable of implementing the described embodiment of FIG. 1 are discussed further with respect to the computing system of FIG. 5.

In the example of FIG. 1, a computing environment 100 is shown including a document comprehension model 102 and a document generation model 104. Each of the document comprehension model 102 and the document generation model 104 may be hosted in a cloud-based infrastructure, where various computing systems can interface with the models 102 and 104 via requests, calls, and other API interactions. The models 102 and 104 are communicatively coupled to one another such that components within one model may overlap with those in the other model.

The document comprehension model 102 is shown including document data source(s) 106, an extraction model 108, AI agent parser 110, and document template blocks 112. Each of the components 106-112 within the document comprehension model 102 are configured to perform a first stage of operations for document generation in the augmented CMS environment. Particularly, the components 106-112 are configured to extract data from documents retrieved from the document data source(s) 106 for storage in a vector database, which enables a set of operations performed by the document generation model 104 in a second stage of operations.

The document data source(s) 106 can include any variety of databases or other data sources such as file systems accessible by a document comprehension model within a cloud-based environment. For example, repositories including financial disclosure documents such as unsecured and personal lending repositories storing a variety of lending documents can be accessed. In another example, technical document repositories storing various technical specifications and standards may be accessed to retrieve relevant documents for feature extraction. In another example still, policies, regulations, and guidelines can be retrieved from respective document data sources 106. Such policies can include one or more of internal policies (i.e. from a privileged database communicatively coupled to the computing environment 100), or external policies (i.e., taken from a variety of regulatory, legal, or best practices repositories).

In some examples, a data preparation service 107 can receive documents from the various document data source(s) 106 prior to forwarding cleansed documents to the extraction model 108. The data preparation service 107 can include programmable logic for analyzing documents and identifying information to redact or otherwise modify within each record prior to reception by the extraction model 108. Information redacted or modified by the data preparation service 107 can include personally identifiable information (“PII”). At the same time, the data preparation service 107 may otherwise preserve the content and structure of the received documents to maintain integrity of the documents for subsequent extraction via the extraction model 108. In other examples, the document data source(s) 106 may already store documents in a cleansed format (e.g., not including PII or other sensitive information) such that the document comprehension model 102 need not include the data preparation service 107, or need not execute operations via the data preparation service.

The documents, either received via the document data source(s) 106 or from the data preparation service 107 can then be applied to the extraction model 108 to decompose each document into a set of features forming extracted features via an AI agent parser 110. Also referred to as the content parser sub-agent, the extraction model 108 can include a text-based LLM trained for parsing text features, or a multi-modal LLM (“MLLM”) further capable of parsing images, designs, and other structural features to extract layout features. The extracted features for each document can include content features and structural features, and in some examples, layout features. In some examples, the extraction model is specifically trained to extract pdf documents and generate output in the form of Markdowns files or JSON files, or other files.

The extracted features generated by the extraction model 108 may then be processed by the AI agent parser 110 to generate document template blocks 112. Also referred to as the content RAG builder sub-agent, the AI agent parser 110 can perform operations related to template blocking and chunking. Blocking and chunking can include generating data objects, including static content and/or dynamic content, from the extracted features to form the document template blocks 112, and further, the chunked blocks 114. The chunked blocks refer to segmented extracted features which may subsequently be used as the base elements in generating templates. The data objects forming the chunked blocks 114 will include a more discretized, segmented version of the extracted feature where each extracted feature may be separated into a plurality of constituent segments or chunks. By segmenting, or “chunking” the extracted features into chunked blocks 114, subsequent queries and prompts generated according to operations during the second stage, performed by the document generation model 104 can be more finely tuned. Additionally, segmenting the extracted features can facilitate more efficient querying the vector database 116 via the AI agent synthesizer 122 as performed during the second stage operations by the document generation model 104. The vector database 116, comprising segmented data compared to unsegmented data, can reduce the number of processing operations in querying the vector database 116 and allowing for greater distribution of processors to operate via parallel processing, while increasing the precision of searching within the vector database. Thus, the AI agent parser can receive as input, the output extracted data generated by the extraction model, such as AI generated JSON output, or AI generated Markdown output, and then produce chunked block 114 outputs, where the chunked blocks can refer to vector embeddings for storage in the vector database 116.

The chunked blocks 114 may then be stored in a vector database 116, also referred to as a vector store. The vector database 116 can include a variety of database formats including relational database such as a structured query language (“SQL”) database, or nonrelational databases such as Java Script Open Notation (“JSON”) database. The chunked blocks, as stored in the vector database 116, may then be retrievable per second stage operations performed by the document generation model 104.

Turning to the document generation model 104 and the architecture for second stage processing, the document generation model 104 is shown including multiple components for interfacing with users, and components for generating target documents via retrieving embeddings form the vector store. The document generation model 104, also referred to as the content generator sub-agent, can receive vector embeddings and apply the vector embeddings to generate target documents 134, such as AI generated JSON outputs, which in turn can be converted to HTML or PDF formats via function calls via REST API layer. The document generation model 104 is shown including a configuration input 118. The configuration input 118 includes rules and parameters defining a request received by a user to generate a target document. The configuration input 118 can include a variety of parameters defining the requirements of the target output document, including terms to be included in the target document, the intended recipients of the target document, a product code associated with the target document disclosure, the format of the output target file, and the like. The configuration input may be received from a graphical user interface or other external system allowing users to provide configuration inputs to the computing environment 100 as received by the document generation model 104. As an example, the configuration input 118 can include data indicating an email needs to be sent to a recipient comprising a closure letter. As another example, the configuration input may be a request to generate a credit card product, where the parameters include a product code with a specified APR.

The configuration input 118 can be received by a rules engine 120 which can include hard-coded logic for parsing the configuration input 118 into code and instructions which may be used to further process the request. The configuration input 118 can be input to both static and dynamic content. The rules engine 120 may identify components of a received request such that an AI agent synthesizer 122 can then retrieve relevant features and blocks for generation of a target document. In some examples, a rules engine 120 may not be provided, and instead only configuration files, as a form of configuration input 118, may be received by the AI agent synthesizer 122. Either via the configuration input 118, the rules engine 120, or a combination of both, a rules-driven engine to support the generative capabilities of the various AI agents. Thus, relevant populations and necessary data can be identified by rule-driven features and then used to retrieve blocks and other elements to generate the target documents.

The configuration input 118, processed to identify the target parameters such as recipient, target disclosure, product type, file format type, or a combination thereof, can then be received by the AI agent synthesizer 122 which can then identify the relevant blocked features from the vector database 116. Thus, the target parameters can be joined to the blocked features systematically to create a query prompt via a prompt generator 124. The prompt generator 124 can generate a query prompt including a combination of rule-driven parameters, as provided by the configuration input 118 or the rules engine 120, in addition to block features retrieved from the vector database 116 via the AI agent synthesizer 122. Particularly, the inclusion of the blocked features provides advantages in priming the generative models within the document generation model 104 to produce outputs similar to the documents extracted by the document comprehension model 102 during the first stage of operations.

The generation model 128, for receiving prompts created by the AI agent synthesizer 122 and prompt generator 124, can include an LLM architecture similar to the extraction model 108. Like the extraction model 108, the generation model 128 can comprise a text-driven LLM or an MLLM capable of generating text and structure to facilitate creation of the target document or content. The output of the generation model can include generated text 130. The text generated via the generation model 128 can include the parameters specified by the configuration input 118 (e.g., including requested terms, information related to the intended recipient, and the like) in a raw format, yet to be formatted into the requested document format. Instead, the raw format can include a txt file, or other text-based data structure lacking a higher-level filetype (e.g., PDF, HTML, or the like).

In some examples, an AI agent evaluator 126 can be included with in the document generation model 104 for providing automatic operations for validating the generated prompts across a variety of metrics and domains prior to feeding the prompts to the generation model 128. The AI agent evaluator 126 can validate against an accuracy domain by generating accuracy metrics to ensure the generated prompts do not contain hallucinations and are accurate according to the chunked blocks and configuration parameters used to create the prompt. The AI agent evaluator 126 can include one or more custom evaluator models to ensure that the generated model is grounded to the source data, and to further establish controls for mitigating the model risk. To perform the validation, the validation can be performed from a query and prompt perspective, where the query can indicate what data to use in produced in the prompt while indicating text and parameters to exclude from the generated prompt. The AI agent evaluator 126 can then compare the prompt against the query to determine the relevancy of the generated prompt (i.e., is the generated text grounded to the source). Based on a variance score comparing the prompt to the input query, the AI agent evaluator 126 can determine whether to reject the prompt prior to inputting the prompt to the generation model 128. For example, thresholds can be set, such as a variance threshold, where variance scores exceeding a threshold value cause the AI agent evaluator 126 to reject the prompt. Additionally, while variance scores can be used to compare the accuracy of the prompt to the query, the AI agent evaluator 126 can perform similar threshold gatekeeping according to other metrics such as related to bias scores, and other metrics indicating the performance of the prompt according to subsequent generation per the generation model 128.

The AI agent evaluator 126 may also be configured to perform similar operations to text generated by the generation model 128, where the AI agent evaluator 126 analyzes the accuracy, completeness, and potential harm of generated text 130 output by the generation model. Similar metrics described with respect to prompt analysis can be applied to generated text.

The AI agent converter 132 can receive the generated text 130. The AI agent converter 132 can identify, for instance based on the configuration input 118, what format of document 134 to generate from the generated text 130. Example formats can include PDF documents, HTML, documents, email objects, and the like. Additionally, the AI agent converter 132 can be communicatively coupled to an interface 138, such as a visualizer, allowing users to select the format of document 134 to create from the generated text 130. Further, the interface 138 can allow users to view the generated text 130 prior to conversion to documents 134 by the AI agent converter 132. Users can then act as gatekeepers to determine whether the generated text 130 is acceptable for conversion to document format and subsequent use.

The interface 138 can also provide a set of evaluation metrics, such as those generated by the AI agent evaluator 126, reflecting the performance and accuracy of the prompt or the generated text 130. The evaluation metrics can be incorporated into files output by the AI agent evaluator 126 which may be stored in the file storage system 136 in addition to the generated documents 134 produced by the AI agent converter 132. The evaluation metrics can include relevancy, bias, and other metrics provided as visual outputs on the interface 138 for manual review, comparison, and debugging. Further, the interface 138 can provide a means for providing a feedback loop within the document generation model 104. For instance, a user may provide feedback to the document generation model 104 via the interface 138 related to generated text 130 outputs. Such feedback can include binary positive and negative feedback and scoring feedback (i.e., out of a five star rating, a ten-point scale, or the like). Feedback may also be processed in a user's rejection of generated text during the document conversion stage per the AI agent converter 132. In some examples, feedback can take the form of adjusting the configuration inputs 118 and restarting the document generation process to produce a new output. The feedback loop, with interface 138 providing the means for receiving the feedback, can thus allow for the performance of the document generation model 104 to be improved over time.

Generated documents 134, created from the generated text 130 via the AI agent converter 132, can be stored in a file storage system 136 for subsequent use according to a variety of services. For instance, various APIs and other interfaces may execute calls to the file storage system 136 for retrieval of specified documents 134. The file storage system 136 may also provide logging of generated documents 134 for versioning, auditing, and other purposes. As discussed above, the interface 138, interacting with the AI agent converter 132 can serve as gatekeeper in allowing or denying storage of generated documents 134 within the file storage system 136. Additionally or alternatively, the file storage system 136 can provide a quarantined storage repository for storage of unapproved documents 134 such that further analysis can be performed on deficient documents, while ensuring that such documents are not accessed by external systems and devices.

### Example Operations of an AI-Augmented Content Management System

FIG. 2 shows an example process for generating documents via an AI-augmented content management system, according to certain examples. For illustrative purposes, the process 200 is described with reference to implementations described above with respect to one or more examples described herein. Other implementations, however, are possible. In some aspects, the operations in FIG. 2 may be implemented in program code that is executed by one or more computing devices such as the computing environment 100 of FIG. 1. In some aspects of the present disclosure, one or more operations shown in FIG. 2 may be omitted or performed in a different order. Similarly, additional operations not shown in FIG. 2 may be performed.

Blocks 202-210 describe a first stage of operations which can be performed by a document comprehension model 102 which are applied to facilitate second stage operations performed by a document generation model 104. The second stage operations can include operations 212-220. Generally, the first stage operations relate to an understanding stage, in which documents can be retrieved from a variety of sources, have relevant features extracted from the documents, and then the extracted features blocked into smaller components and converted into vectors for storage in a vector database 116. The vectors may then be retrieved during the second stage, as described with respect to operations 212-220.

At block 202 the process 200 includes generating a set of document block vectors. The document block vectors represent the base components necessary to generate documents during the second stage operations. For instance, document blocks can refer to sub-portions of a document, such as into constituent paragraphs, terms, or the like. Those blocks may be converted into features (e.g., embeddings), for search and retrieval, as stored in the vector database 116. The particular processes for generating the set of document block vectors, discussed at a high level per block 202, are discussed more fully according to blocks 204-210.

At block 204 the process 200 includes retrieving a set of documents from one or more document data source(s). The document data source(s) can include document data source(s) 106. Examples of document data source(s) 106 can include policy-driven data sources such as compliance databases, databases storing internal or external policies, legal and regulatory databases, and the like. Document data source(s) 106 can also include technical or financial databases storing technical or financial documents, respectively. For example, financial product databases, including information related to various credit packages, offers, and credit terms including APR information can be provided. The set of documents can be received or retrieved from the document data source(s) 106. In an example, web-scrapers or other agents may be configured to monitor document data source(s) 106 such as websites or other external sources to maintain an updated record of the set of documents.

At block 206 the process 200 includes extracting, for each document of the set of documents, content features and structural features. Extraction can be performed by an extraction model 108, where the extraction model 108 can include a text-based LLM or an MLLM capable of processing and outputting text, among other features such as structural features. The extraction model 108 can extract, among other features, content features and structural features. Content features can refer to the textual content of the received documents, including specific terms, policies, statements, and other language. Examples of content features can include product overview, eligibility criteria, financial terms, risk disclosure, benefits, legal and regulatory information, and the like. Structural features can refer to the organization of the content features within the retrieved documents, such as the ordering of different content within the document. Examples of structural features can include the organization and arrangement of each of the title page, table of contents, body sections, financial terms and conditions, including the organization of each term and condition, signature blocks, and the like. Thus, content of each document, and its structural organization within the document can each be extracted for subsequent processing by the document comprehension model.

In further examples, other features that can be extracted from the retrieved documents can include layout features. Layout features can include features such as page layout, text formatting, paragraph structure, tables and charts, and other features related to how content is visually organized and presented in the document.

At block 208 the process 200 includes decomposing the content features and the structural features into the set of document block vectors. The AI agent parser 110 may be configured to perform operations including blocking the extracted features into document template blocks 112 and chunked blocks 114, in addition to converting the chunked blocks into vectors, such that the extracted features can be decomposed into document block vectors. Segmentation and blocking of extracted content features can include segmenting content base components. As an example, APR values may be identified as a first block component, while a specific risk disclosure may be identified as a second block component, and a specific definition of a given term may be identified as a third block component. Similarly, segmentation and blocking of extracted structural features be performed. Blocking and segmentation of the extracted features can be performed by creating separate data structures for each generated segment.

Once the segmented elements are generated (e.g., as stored in individual data structures), the AI agent parser 110 into document template blocks 112 can be further converted from segmented, chunked elements into feature vectors. Various encoding and embedding applications may be used to encode the blocked content elements and blocked structural elements into respective feature vectors, such as via bag of words models, term frequency-inverse document frequency (“TF-IDF”) models, word embeddings, one-hot encoding, n-gram encoding, and the like. While the process 200 at block 208 is described with respect to content features and structural features, it is to be appreciated that a similar process of blocking and encoding may be applied to other features, such as layout features.

At block 210 the process 200 includes storing the set of document block vectors in a vector database. The vector database 116 can include a variety of database formats including relational databases such as SQL databases, or nonrelational databases such as JSON databases. The chunked blocks, as stored in the vector database 116 may then be retrievable per second stage operations described with respect to operations 212-220 of the process 200.

At block 212 the process 200 includes generating a target document. The target document can refer to a target output of a content management system for application external to the content management system. For example, in certain contexts, the target document can refer to a lending document such as an unsecured lending document such as a loan, credit card agreement, line of credit, or a secured lending documents such as mortgage agreements, deeds, security agreements, and the like.

At block 214 the process 200 includes receiving user input including a configuration of the target document. The configuration, or configuration input 118, can include various parameters defining the requirements of the target document to be generated. Example parameters can include the recipient(s) of the target document, specific content to be included in the target document, such as specific terms, conditions, disclosures, and the like, specific formatting and file-type, or any other parameter controlling the contents, structure, layout, and recipients of the target document.

At block 216 the process 200 includes retrieving, based on the configuration, one or more document block vectors from the vector database. A rules engine 120, coupled to an AI agent synthesizer 122 can communicate with one another and with the vector database 116 to identify specific blocked vectors from the vector database 116. For instance, a configuration input identifying the target recipient can assist the AI agent synthesizer 122 in identifying which document block vector to retrieve from the vector database 116. The AI agent synthesizer 122 can systematically marry the configuration input 118 data with the retrieved document block vector to create a query prompt which, after optionally being grounded via an AI agent evaluator 126, be input into a generation model 128 per block 218.

At block 218 the process 200 includes generating a target text output based on the one or more document block vectors and the configuration. The query prompt, generated per block 216 based on the configuration input 118 and the retrieved document block vector from the vector database 116, can produce generated text 130 after the prompt is input into the generation model 128. Per block 218, the generated text 130 will be provided as a pure text output (i.e., without formatting). In some examples, the AI agent evaluator 126, which can be used to verify the accuracy of the prompt fed into the generation model, can also be used to verify the accuracy of the generated text 130. Metrics scoring hallucinations, accuracy, or risks of other harmful outputs such as bias can be automatically measured via the AI agent evaluator 126 to validate the output of the generation model 128. Additionally, interface 138 may directly monitor and review the generated text 130 in the unformatted state prior to converting the generated text into a document or structured file according to block 220. Thus, additional layers of review may be implemented throughout process 200 to ensure the accuracy, completeness, and helpfulness of generated text 130 generated in the second stage of operations performed by the document generation model 104.

In further examples, the generation model 128, can further output not only generated text 130, but generated formatted documents. In such examples, the extraction model operating in the document comprehension model 102, can operate as an MLLM, capable of extracting not only content features and structural features, but also layout features. The layout features may be stored in the vector database 116 in document block vectors similar to the content features and structural features. Then, the configuration input 118 may include document and layout instructions, which can allow for the targeted retrieval of layout block vectors, which may be parsed by the generation model 128, as another MLLM, capable of generating structured formatted files.

At block 220 the process 200 includes converting the target text output into the target document. The generated text 130 can be output to an AI agent converter 132, which like the AI agent synthesizer 122, can include hard-coded logic to facilitate operations of the document generation model 104. An interface 138 may allow for user input to define the layout and file format of the generated documents 134 created by the AI agent converter 132, in addition to allowing for review and modification of the generated text 130 during the conversion process to the generated documents 134. Once approved, via the interface 138, the generated documents 135 can be stored in a file storage system 136 for subsequent retrieval (e.g., via API calls) via client computing systems with access to the computing environment. The file storage system 136 may also store the generated documents 134, for versioning, auditing, performance analysis, and other review purposes.

FIGS. 3-4 show a formatted document generated via an AI-augmented content management system, according to certain examples. The above-described AI-augmented content management system can be used to generate various types of documents. That is, the system can be used to generate disclosure letters for a variety of products, such as financial service products, consumer goods products, etc. In the example of FIGS. 3-4, an example generated document is shown. FIG. 3 shows a first page of the document, while FIG. 4 shows a second page of the document.

By applying the described document comprehension model 102 and document generation model 104, the described system can generate documents for a variety of users in an efficient manner, with minimal need for human-in-the-loop intervention. Instead, configuration inputs 118 can be keyed to each entity to allow prompts to be generated and applied for each entity in generating corresponding documents like that shown in FIGS. 3-4. Additionally, changes in formatting and more substantive changes to documentation may each be caught by the document comprehension model 102 and routinely updated in the vector database 116. As a result when the document generation model 104 accesses the vector database 116 when generating target documents 134, the changes in formatting and form content will automatically be captured.

### Example Computing Environment for an AI-Augmented Content Management System

Any suitable computing system or group of computing systems forming a computing environment can be used for performing the operations described herein. For example, FIG. 5 shows a block diagram for a computing environment 500 capable of executing the described systems and methods, according to certain examples.

The depicted example of a computing system 502 includes one or more processors 506 communicatively coupled to one or more memory components 504. The processor 506 executes computer-executable program code or accesses information stored in the memory component 504 (e.g., a memory device). Examples of processor 506 include a microprocessor, an application-specific integrated circuit (“ASIC”), a field-programmable gate array (“FPGA”), or other suitable processing device. The processor 506 can include any number of processing devices, including one.

The memory component 504 includes any suitable non-transitory computer readable medium for storing instructions for executing operations of the document comprehension model 522, the document generation model 524, the interface 526, or other dynamic instructions 528. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 502 may also include a number of external or internal devices such as input or output devices. For example, the computing system 502 is shown with an input/output (“I/O”) interface 510 that can receive input from input devices or provide output to output devices. A bus 508 can also be included in the computing system 502. The bus 508 can communicatively couple one or more components of the computing system 502.

The computing system 502 executes program code that configures the processor 506 to perform one or more of the operations described above with respect to FIGS. 1-2. The program code includes operations related to, for example, configuring event listeners to retrieve data, extract features from the data, segment and encode the data into features, or other suitable applications or memory structures that perform one or more operations described herein. The program code may be resident in the memory component 504 or any suitable non-transitory computer-readable medium and may be executed by the processor 506 or any other suitable processor. In some embodiments, the program code described above including instructions for executing the document comprehension model 522, the document generation model 524, the interface 526, or other dynamic instructions 528 are stored in the memory component 504, as depicted in FIG. 5. In additional or alternative embodiments, one or more of the instructions for executing the document comprehension model 522, the document generation model 524, the interface 526, or other dynamic instructions 528 described above are stored in one or more memory components accessible via a data network 514, such as a memory component accessible via a cloud service.

The computing system 502 depicted in FIG. 5 also includes at least one network interface 512. The network interface 512 includes any device or group of devices suitable for establishing a wired or wireless data connection to one or more data networks 514 such as viewing applications 520 including user interfaces. Non-limiting examples of the network interface 512 include an Ethernet network adapter, a modem, and/or the like. A remote communication service 518 is connected to the computing system 502 via network 514 and can perform some of the operations described herein configuring event listeners to retrieve data, aggregate event data into actions, train and apply machine learning models based on attributes. The computing system 502 is able to communicate with one or more of the remote communication service 518 and data sources 516. Data sources 516 can include any of the data sources according to the examples described herein, such as the document data source(s) 106, or the vector database 116. In other examples, one or more of the data sources 516 can be stored within the computing system 502 such that transmission across network 514 is not necessary.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

1. A method comprising:
in a first stage, generating a set of document block vectors through steps comprising:
retrieving a set of documents from one or more document repositories;
extracting, for each document of the set of documents, and via an extraction model, content features, and structural features;
decomposing the content features and the structural features into the set of document block vectors; and
storing the set of document block vectors in a vector database;
in a second stage, generating a target document, through steps comprising:
receiving user input including a configuration of the target document;
retrieving, based on the configuration, one or more document block vectors from the vector database;
generating, via a generation model, target text output based on the one or more document block vectors and the configuration; and
converting the target text output into the target document.

2. The method of claim 1, wherein the first stage further comprises, prior to extracting content features and structural features:
cleansing the set of documents via identifying and removing personally identifiable information from each document of the set of documents.

3. The method of claim 1, wherein the first stage further comprises extracting, for each document of the set of documents, and via the extraction model, layout features and wherein the layout features are decomposed into the set of document block vectors for storing in the vector database; and
in the second stage, generating, via the generation model, the target document based in part on the layout features.

4. The method of claim 1, wherein the second stage further comprises, scoring, by an agent evaluator, a prompt used to generate the target text output, where the scoring indicates one or more of a completeness, accuracy, or bias of the target text output.

5. The method of claim 1, further comprising, receiving feedback via an interface related to the generation of the target text output, wherein the feedback causes the generation model to adjust an output of the generation model.

6. The method of claim 1, wherein the target document is a credit card disclosure document.

7. The method of claim 1, wherein the extraction model comprises a first large language model and the generation model comprises a second large language model different from the first large language model.

8. The method of claim 1, wherein the one or more document repositories includes an internal privileged policy repository, and an external policy repository.

9. A system comprising a memory device and one or more processors for executing operations comprising:
in a first stage, generating a set of document block vectors through steps comprising:
retrieving a set of documents from one or more document repositories;
extracting, for each document of the set of documents, and via an extraction model, content features, and structural features;
decomposing the content features and the structural features into the set of document block vectors; and
storing the set of document block vectors in a vector database;
in a second stage, generating a target document, through steps comprising:
receiving user input including a configuration of the target document;
retrieving, based on the configuration, one or more document block vectors from the vector database;
generating, via a generation model, target text output based on the one or more document block vectors and the configuration; and
converting the target text output into the target document.

10. The system of claim 9, wherein the first stage further comprises, prior to extracting content features and structural features:
cleansing the set of documents via identifying and removing personally identifiable information from each document of the set of documents.

11. The system of claim 9, wherein the first stage further comprises extracting, for each document of the set of documents, and via the extraction model, layout features and wherein the layout features are decomposed into the set of document block vectors for storing in the vector database; and
in the second stage, generating, via the generation model, the target document based in part on the layout features.

12. The system of claim 9, wherein the second stage further comprises, scoring, by an agent evaluator, a prompt used to generate the target text output, where the scoring indicates one or more of a completeness, accuracy, or bias of the target text output.

13. The system of claim 9, wherein the operations further comprise:
receiving feedback via an interface related to the generation of the target text output, wherein the feedback causes the generation model to adjust an output of the generation model.

14. The system of claim 9, wherein the target document is a credit card disclosure document.

15. A non-transitory computer readable medium storing instructions, which when executed by one or more processors, cause the one or more processors to perform operations comprising:
in a first stage, generating a set of document block vectors through steps comprising:
retrieving a set of documents from one or more document repositories;
extracting, for each document of the set of documents, and via an extraction model, content features, and structural features;
decomposing the content features and the structural features into the set of document block vectors; and
storing the set of document block vectors in a vector database;
in a second stage, generating a target document, through steps comprising:
receiving user input including a configuration of the target document;
retrieving, based on the configuration, one or more document block vectors from the vector database;
generating, via a generation model, target text output based on the one or more document block vectors and the configuration; and
converting the target text output into the target document.

16. The non-transitory computer readable medium of claim 15, wherein the first stage further comprises, prior to extracting content features and structural features:
cleansing the set of documents via identifying and removing personally identifiable information from each document of the set of documents.

17. The non-transitory computer readable medium of claim 15, wherein the first stage further comprises extracting, for each document of the set of documents, and via the extraction model, layout features and wherein the layout features are decomposed into the set of document block vectors for storing in the vector database; and
in the second stage, generating, via the generation model, the target document based in part on the layout features.

18. The non-transitory computer readable medium of claim 15, wherein the second stage further comprises, scoring, by an agent evaluator, a prompt used to generate the target text output, where the scoring indicates one or more of a completeness, accuracy, or bias of the target text output.

19. The non-transitory computer readable medium of claim 15, wherein the operations further comprise:
receiving feedback via an interface related to the generation of the target text output, wherein the feedback causes the generation model to adjust an output of the generation model.

20. The non-transitory computer readable medium of claim 15, wherein the target document is a credit card disclosure document.
